(19) United States
(12) Patent Application Publication
(10) Pub. No.: US 2002/0102997 A1
(43) Pub. Date: Aug. 1, 2002

(54) Method for synchronizing data base of cordless communication sites

(76) Inventor: Yuan-Sheng Pan, Taipei (TW)

Correspondence Address: Andrew Cheng, 22928 Estoril Drive #5, Diamond Bar, CA, 91765, US

(21) Appl. No.: 09/772,629

(22) Filed: Jan. 30, 2001

(51) Int. Cl. H04Q 7/20; H04B 7/005; H04B 7/01; H04B 7/015; H04B 15/00

(52) U.S. Cl. 455/462; 455/502

(57) ABSTRACT

A data base synchronization method of cordless communication sites is disclosed. The data base synchronization method includes steps of: a calling site sending a data base synchronization request signal via a selected communication channel to at least one called site; the called site scanning and receiving the data base synchronization request signal and sending the status data stored in the memory thereof to the calling site so that the status data of the calling site can be synchronized with the status data of the called site. The synchronization method provides data base synchronization of cordless communication modules of several base sites and handset sites so that in a whole cordless communication system or a whole data network system, no matter the communication is performed from a base site to another base site, a base site to a handset site, a handset site to a base site, or a handset site to another handset site, the data base synchronization is performed of the calling sites and called sites.

### BACKGROUND OF THE INVENTION

1. Field of the Invention

The present invention relates to a cordless telephone communication system or cordless data network system, and especially to a data base synchronization method for synchronizing data base of communication sites of a cordless communication system or cordless data network system.

2. Description of the Prior Art

Traditional cordless communication system generally is equipped with a main switching unit. The main tele or data switching unit allows the individual communication units to connect to any one of a number of communication lines in connection with the tele or data switching unit. However, the traditional main tele or data switching unit is very expensive and complicated for manufacture not meeting the requirement of a small business. Moreover, the traditional tele or data switching unit system lacks function of interphone communication of the handsets. It is required to provide a new method for overcoming the problems occurred in the traditional tele or data switching system.

### SUMMARY OF THE INVENTION

Therefore, the primary purpose of the present invention is to provide a data base synchronization method of cordless communication modules so that base sites and handset sites of a cordless communication system when turned on, initiated, or needing data base synchronization can perform a data base synchronization procedure to the cordless communication modules for enabling memories of the base sites and the handset sites to keep in a most updated system status.

Another purpose of the present invention is to provide a data base synchronization method of cordless communication modules of several base sites and handset sites so that in a whole cordless communication system or a whole data network system, no matter the communication is performed from a base site to another base site, a base site to a handset site, a handset site to a base site, or a handset site to another handset site, the data base synchronization can be performed in each base site and each handset site.

According to one aspect of the present invention there is provided a data base synchronization method of a calling site and a plurality of called sites. The data base synchronization method comprises steps of: a calling site sending a data base synchronization request signal via a selected communication channel to at least one called site; the called site scanning and receiving the data base synchronization request signal and sending the status data stored in the memory thereof to the calling site so that the status data of the calling site can be synchronized with the status data of the called site. The synchronization method provides data base synchronization of cordless communication modules of several base sites and handset sites so that in a whole cordless communication system or a whole data network system, no matter the communication is performed from a base site to another base site, a base site to a handset site, a handset site to a base site, or a handset site to another handset site, the data base synchronization is performed of the calling sites and called sites.

### BRIEF DESCRIPTION OF THE DRAWINGS

The present invention will be described in further detail with reference to the accompanying drawings, wherein:

FIG. 1 is a system block diagram in accordance with the present invention;

FIG. 2 is a data format of the communication request signal used in the present invention;

FIG. 3 is a flow chart showing a calling handset site is performing a data base synchronization to called base sites;

FIG. 4 is a flow chart showing a calling base site is performing a data base synchronization to called handset sites;

FIG. 5 is a flow chart showing a calling handset site is performing a data base synchronization to another handset sites; and

FIG. 6 is a flow chart showing a calling base site is performing a data base synchronization to another base site.

### DETAILED DESCRIPTION OF THE PREFERRED EMBODIMENTS

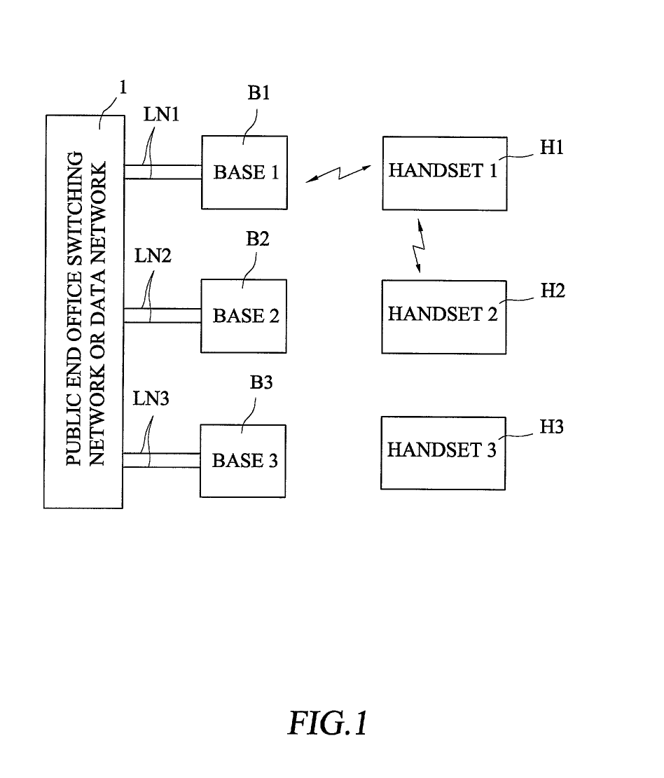

Referring to FIG. 1, a system block diagram in accordance with a preferred embodiment of the present invention is shown. In this embodiment, three cordless base sites B1, B2, B3 and three cordless handset sites H1, H2, and H3 are taken as an example for explanation purpose. The cordless base sites B1, B2, and B3 are respectively connected to communication lines LN1, LN2, and LN3 of a public end office switching network or data network 1. Each of the cordless handset sites H1, H2, H3 may communicate with any one of the base sites B1, B2, and B3. The handset sites H1, H2, and H3 may also communicate with each other. The communication lines LN1, LN2, LN3 may be a subscriber line, a data communication line, or a data bus.

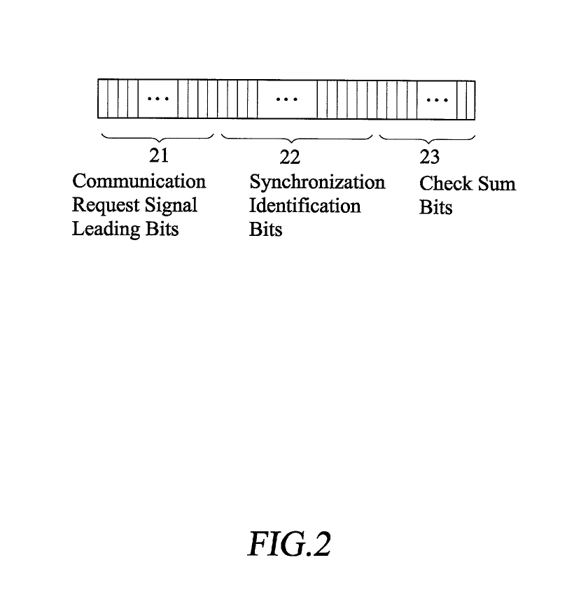

Referring to FIG. 2, a data format of the communication request signal used in the present invention is shown. The data format of the communication request signal comprises a plurality of communication request signal leading bits 21, a plurality of synchronization identification bits 22, and a plurality of checking bits 23. The bit sequences of the synchronization identification bits 22 are associated with a predetermined serial number of a corresponding called sites.

When the calling site sends out the communication request signal to several called sites via a selected communication channel, all the synchronization identification bits are initially set to “0”. When the called site receives the communication request signal, it will send out a system status data to the calling site. When the calling site receives the system status data from any one of the called sites, it will set a predetermined one of the synchronization identification bits corresponding to the called site to “1” to indicating that the calling site has been data synchronized with the specific called site.

After this, the calling site will still send out a communication request signal in a predetermined time period, such as two seconds. However, the called site which has been data synchronized with the calling site when receiving the communication request signal will make sure data base synchronization from the logic status (logic “1”) of the specific synchronization identification bit, and it will not send out the system status data. For other called sites not yet synchronized will follow the same procedure to send out the system status data to the calling site.

A time slot method may be used in the above signal transmission. By this method, a time slot code is added in the communication request signal leading bits 21. When the called site receives the communication request signal leading bits 21 and time slot coding bits representing the time slot code, it will know at which time slot for sending the system status data to the calling site. By this method, the synchronization identification bits 22 and the related identification procedure may be omitted.

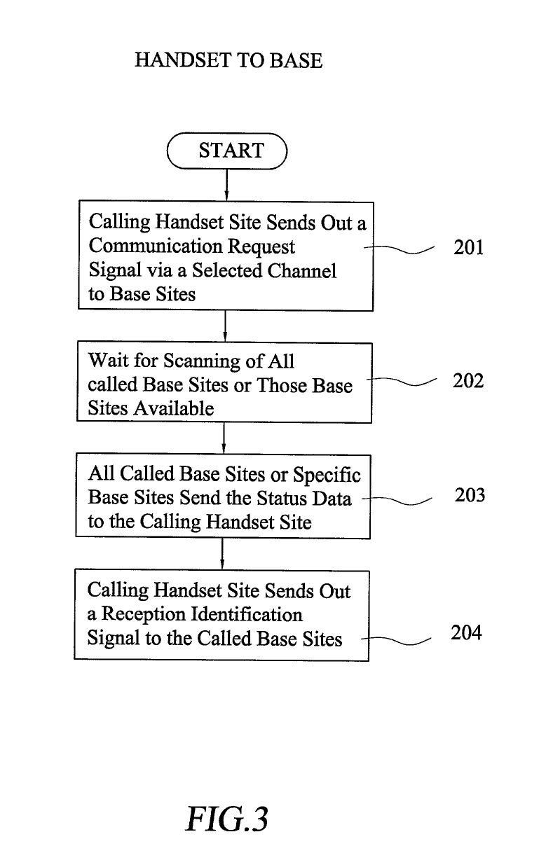

The procedures of the present invention will be described with reference to FIGS. 3 through 6. When two cordless communication sites (for example, a handset site to a base site, a handset site to another handset site, a base site to a handset site, or a base site to another base site) perform data base synchronization, firstly, the calling site sends a communication request signal via a selected communication channel to the called site.

The communication request signal may be one of the following signals: a signal which is generated due to turning on of a power switch of the calling site; a signal by which a user requires to communicate with the called site, when the calling site is in a stand-by status; a signal by which a user requires to display or update the status data of the called site, when the calling site is in a stand-by status; or a signal generated by the calling site in a predetermined time period. The communication type of the calling site and the called site may be either telecommunication or data-communication, and the signal type may be either analog type or digital type.

Procedures of Data Base Synchronization

1. Handset Site to Base Site

Referring to FIG. 3, a flow chart showing data base synchronization procedures from a handset site (calling site) to a base site (called site) is shown. This flow chart may happen when the power of the handset site is turned on, or when the handset site requires to display or update status of all the out-line loops and the system (including system registration, ring call etc.), or when the handset site requires to communicate through subscriber lines, or when the handset site requires to update data at a predetermined time period.

The procedures of this control include: firstly, the calling handset site sends out a communication request signal via a selected communication channel to the called base sites (step 201) and waits for the scanning of all called base sites or those base sites which are available (step 202). The called base site will reply, when it scans the calling handset site. The reply may be performed by either sending the status data stored in a memory database of the called base site to the calling handset site (step 203) or sending a reply signal to the calling handset site first and then sending the status data to the calling handset site later. When the called base site has sent out the status data, the calling handset site can store the status data of all base sites or those base sites which are available. After performing the database synchronization procedure, the calling handset site may or may not send out a reception identification signal to the called base sites (step 204).

2. Base Site to Handset Site

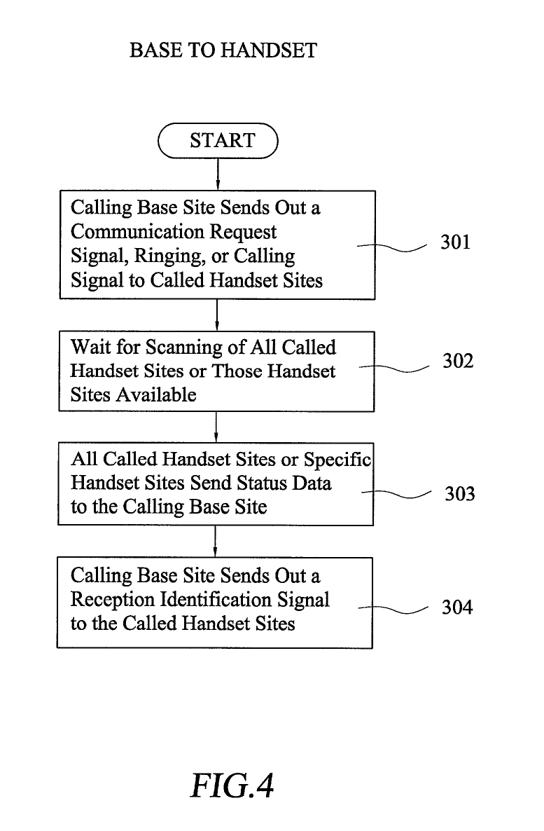

With reference to FIG. 4, it is a flow chart showing data base synchronization procedures from a base site (calling site) to a handset site (called site). This flow chart may happen when the calling base site requires to display status of called handset sites, when the calling base site requires to send a ringing signal or calling signal to the called handset sites, or when the calling base site requires to fetch or update status data of the called handset sites at any times.

The procedures as shown in FIG. 4 include: the calling base site sends out a communication request signal, ringing signal, or calling signal via a selected communication channel to the called handset sites (step 301), and then waits for scanning of all called handset sites or those handset sites which are available (step 302). The called handset site will reply, when it scans the calling base site. The reply may be performed by either sending the status data stored in a memory database of the called handset site to the calling base site (step 303) or sending a reply signal to the calling base site first and then sending the status data to the calling base site later. When the called handset site has sent out the status data, the calling base site can store the status data of all handset sites or those handset sites which are available. After performing the database synchronization procedure, the calling base site may or may not send out a reception identification signal to the called handset sites (step 304).

3. Handset site to Handset Site

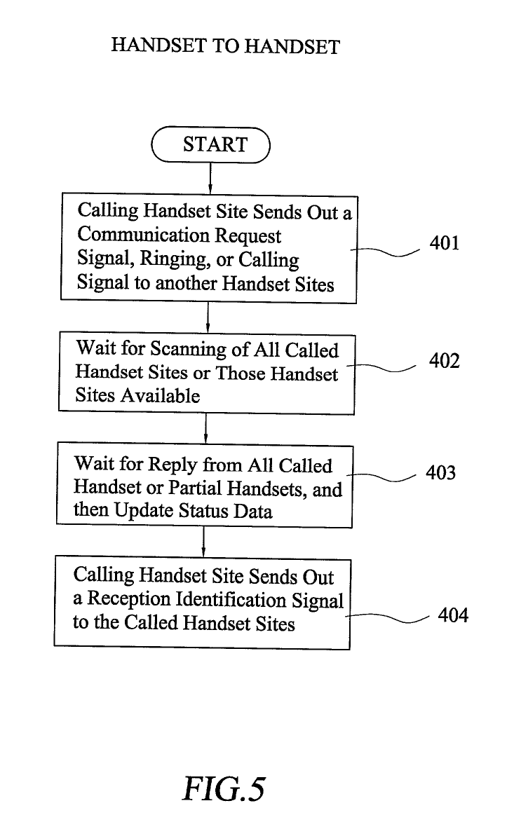

With reference to FIG. 5, it is a flow chart showing data base synchronization procedures from a calling handset site to another handset sites. This flow chart may happen when the calling handset site requires to display status of called handset sites, when the calling handset site requires to send a ringing signal or calling signal to the called handset sites, or when the calling handset site requires to fetch or update status data of the called handset sites at any times.

The procedures as shown in FIG. 5 include: the calling handset site sends out a communication request signal, ringing signal, or calling signal via a selected communication channel to the called handset sites (step 401), and then waits for scanning of all called handset sites or those handset sites which are available (step 402). The called handset site will reply, when it scans the calling handset site. The reply may be performed by either sending the status data stored in a memory database of the called handset site to the calling handset site (step 403) or sending a reply signal to the calling handset site first and then sending the status data to the calling handset site later. When the called handset site has sent out the status data, the calling handset site can store the status data of all handset sites or those handset sites which are available. After performing the database synchronization procedure, the calling handset site may or may not send out a reception identification signal to the called handset sites (step 404).

4. Base site to Base site

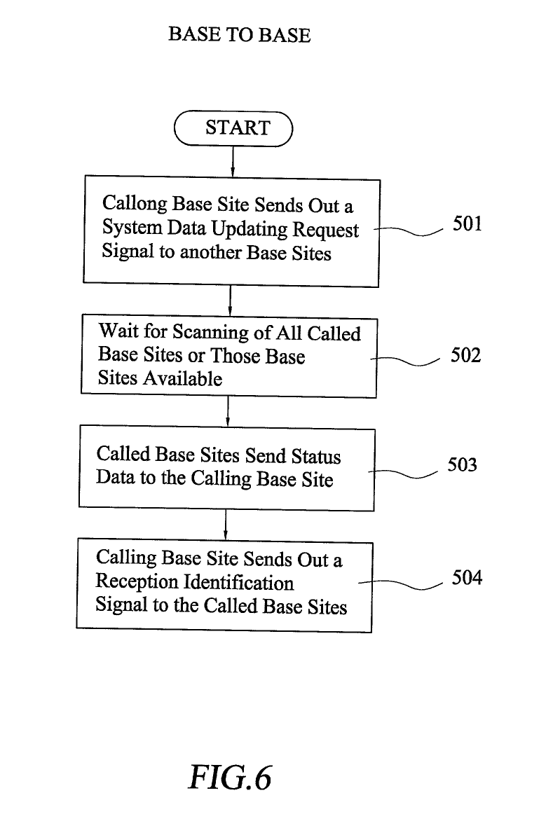

With reference to FIG. 6, it is a flow chart showing data base synchronization procedures from a calling base site to another base sites. This flow chart may happen when the calling base site requires to display or update status of another base sites, when the calling base site requires to fetch or update status data of another base sites at any times.

The procedures as shown in FIG. 6 include: the calling base site sends out a system updating request signal via a selected communication channel to another base sites (step 501), and then waits for scanning of all called base sites or those base sites which are available (step 502). The called base site will reply, when it scans the calling base site. The reply may be performed by either sending the status data stored in a memory database of the called base site to the calling base site (step 503) or sending a reply signal to the calling base site first and then sending the status data to the calling base site later. When the called base site has sent out the status data, the calling base site can store the status data of all base sites or those base sites which are available. After performing the database synchronization procedure, the calling base site may or may not send out a reception identification signal to the called base sites (step 504).

It is to be understood from the above description that the present invention can provide a data base synchronization method of cordless communication modules for enabling the base sites and the handset sites of a cordless communication system to achieve data base synchronization for maintaining the memory of the base sites or handset sites in a most updated system status, no matter the base sites and the handset sites are turned on, initiated, or just in a condition when the data base synchronization is required. With the present invention, all the base sites and handset sites in a cordless communication system may achieve data base synchronization no matter from a handset site to a base site, a handset site to another handset site, a base site to a handset site, or a handset site to another handset site, and no matter the base sites and handset sites are turned on, initiated, or just in a condition when data base synchronization is required.

While the present invention has been described with reference to specific embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

What is claimed is:

1. A method for synchronizing data base of a calling site and a plurality of called sites, comprising the following steps:
(a) scanning and selecting a communication channel;
(b) the calling site sending a communication request signal with a predetermined data format to the called sites via the selected communication channel;
(c) the called sites scanning and receiving the communication request signal; and
(d) the called site sending status data stored therein to the calling site so that the status data of the calling site is synchronized with the status data of the called site.

2. The data base synchronization method as claimed in claim 1, wherein the calling site is a cordless handset site and the called site is a cordless base site.

3. The data base synchronization method as claimed in claim 2, wherein the base site is connected to a communication line.

4. The data base synchronization method as claimed in claim 1, wherein the calling site is a cordless base site and the called site is a cordless handset site.

5. The data base synchronization method as claimed in claim 4, wherein the base site is connected to a communication line.

6. The data base synchronization method as claimed in claim 1, wherein the calling site is a cordless handset site and the called site is a cordless handset site.

7. The data base synchronization method as claimed in claim 1, wherein the calling site is a cordless base site and the called site is a cordless base site.

8. The data base synchronization method as claimed in claim 7, wherein the base site is connected to a communication line.

9. The data base synchronization method as claimed in claim 1, wherein the communication request signal is generated by turning on a power of the calling site.

10. The data base synchronization method as claimed in claim 1, wherein the communication request signal is generated due to a need to communicate from a calling site to a called site when the calling site is in a stand-by status.

11. The data base synchronization method as claimed in claim 1, wherein the communication request signal is generated due to a requirement from a calling site to display or update status data of the called site when the calling site is in a stand-by status.

12. The data base synchronization method as claimed in claim 1, wherein the communication request signal is generated when the calling site is performing system registration.

13. The data base synchronization method as claimed in claim 1, wherein the communication request signal is generated when the calling site is performing a ring call.

14. The data base synchronization method as claimed in claim 1, wherein the communication request signal is generated by the calling site at a predetermined time period.

15. The data base synchronization method as claimed in claim 1, wherein the communication request signal has a data format comprising a plurality of communication request signal leading bits and a plurality of synchronization identification bits.

16. The data base synchronization method as claimed in claim 15, wherein a sequence of the synchronization identification bits is associated with a serial number of the called sites.

17. The data base synchronization method as claimed in claim 15, wherein the synchronization identification bit has two states, a first state representing that the called site has been data synchronized with the calling site, and a second state representing that the called site has not been data synchronized with the calling site; and wherein when the calling site sends the communication request signal with the data format to the called sites via the selected communication channel, all the synchronization identification bits of the communication request signal are set to be the second state, when any of the called sites receives the communication request signal, it sends the system status data to the calling site, and when the calling site receives the system status data from any of the called sites, it sets a corresponding one of the synchronization identification bits to be the first state, representing that the calling site has been data synchronized with the called site.

18. The data base synchronization method as claimed in claim 17, wherein the calling site continues to send out the communication request signal at a predetermined time period, and wherein the called site which has been data synchronized with the calling site makes sure from the synchronization identification bits that it has been data synchronized with the calling site, while the other called sites which have not been data synchronized with the calling site send the system status data to the calling site.

19. The data base synchronization method as claimed in claim 1, wherein the communication request signal has a data format including a plurality of communication request signal leading bits and a plurality of time slot coding bits, and wherein the called site can decide at which time slot to send the system status data to the calling site when the called site receives the communication request signal leading bits and the time slot coding bits.
